(19) United States
(12) Patent Application Publication
(10) Pub. No.: US 2024/0023208 A1
(43) Pub. Date: Jan. 18, 2024

(54) CONTROL METHOD FOR INDUCTION HEATING MACHINE AND RELATED MACHINE

(71) Applicant: NUOVA SIMAT S.R.L., Collesalvetti (IT)

(72) Inventors: Giulia STRAMBI, Livorno (IT); Vincenzo GENOVESE, Vicopisano (IT); Stefano LUSCHI, Livorno (IT)

(21) Appl. No.: 17/770,376

(22) PCT Filed: Oct. 8, 2020
(86) PCT No.: PCT/IB2020/059458

§ 371 Date: Apr. 20, 2022

(30) Foreign Application Priority Data
Oct. 24, 2019 (IT) 102019000019756

(51) Int. Cl. H05B 6/06

(52) U.S. Cl. CPC H05B 6/06; H05B 6/14

(57) ABSTRACT

The present invention relates to a portable induction machine for performing tightening and releasing procedure and in particular to a system for controlling the machine head. The machine is applied in particular in the maintenance procedures of big machines for the energy generation, where it is necessary to tighten the tie rods.

The present invention is used in the field of the machines for heating by magnetic induction, in particular for performing procedures of tightening/releasing the tie rods in the turbines.

Such machines, by performing the heating of mechanical components, such as for example hollow linkage, in particular allow to disassemble and to assemble machines for the production of electric energy.

### BACKGROUND

The tightening/releasing of nuts and bolts has always represented one of the critical points of the construction and maintenance of big machines, in particular of the big machines for the energy production.

The procedure is burdensome due to the great forces at play and the considerable commitment of time and operating resources.

In order to perform the tightening/releasing of the nuts and bolts having big sizes, it is necessary to cause a determined lengthening of the screw. Such lengthening is obtained through the direct or indirect application of an axial force cold applied or applied by means of thermal expansion.

A cold, direct lengthening can be obtained by means of hydraulic tensioners, that is apparatuses which generate on the screw a pre-established traction force.

The tensioners consist of a bushing (provided with radial holes in order to able to tighten/release the nut with a suitable bar), of a hydraulic cell and a threaded adapter to be positioned on the nut's screw. By applying hydraulic pressure, the screw lengthens as far as the wished value, thus allowing the bushing to rotate on the nut for the tightening or releasing. This system then provides that a portion of threaded screw projects from the nut, to allow to assemble the threaded adapter: this condition, especially in case of big turbines, does not occur frequently and then prevents the use of hydraulic tensioners.

In an indirect, still cold, way, the lengthening can be obtained, instead, even by means of using hydraulic wrenches, that is tools capable of developing a determined tightening (or releasing) torque. The hydraulic wrenches actuate by means of a hydraulic central unit which determines the oil pressure and then the wished torque (each wrench is accompanied by a conversion table wherein it is possible to find matching between set pressure and delivered torque value). However, this method tends to create a strong dispersion in the pre-load values due to the influence of continuously variable parameters, difficult to be defined, such as the friction coefficient in threads and contact surfaces.

Still in an indirect, but hot, way, said lengthening can be obtained by exploiting the material thermal expansion. The traditional methods generate heating by using an electric resistance having elongated shape to be inserted inside an axial blind or through hole in the screw. The hollow linkage of big electric machines generally has such requisites. The heating by conduction, however, has several disadvantages, thereamong the high time in performing the work and the poor safety of operators. The operator, in fact, has to manipulate the incandescent spark plug by running potential risks of injury (for example burns or electric electrocutions).

The material thermal expansion can be implemented even by magnetic induction; a system which allows to transfer huge amounts of energy in a short time through a properly generated magnetic field.

Of all described methods, the indirect, hot one, using the magnetic induction, is by far the favourite one, since where there is the need for tightening and releasing nuts and bolts having big sizes and high mechanical resistance, it results to be highly safe for the operators. Moreover, it decreases considerably the time of procedures and operating temperatures.

Currently there are several devices on the market which operate based upon this principle.

By way of example the machines having Minac and Maximinac trademark, produced by EFD Induction Group, can be mentioned, which implement heating of tie rods by means of induction heads. These machines, however, suffer from some limits, in particular the fact of not having an internal cooling system, which involves the presence of bulky external chillers, awkward to be handled, with higher risk from the point of view of operator safety; moreover they have quite complex control panels and above all they do not provide the possibility of connecting/disconnecting the connection cables between the machine and the heating head, procedure which would allow to replace timely the heating head by avoiding to cause stopping the procedures which, in case of high-pressure turbines in the power plants, can result to be highly critical and expensive.

Another example of apparatus on the market is Hi Heater machine, produced by Dai-Ichi High Frequency Co. Ltd. However, this machine too does not represent an optimum solution to the operators' needs, in particular as it is characterized by a transformer constituted by a separate unit, without any handle, having a weight higher than 20 kg, which requires an external system in order to be lifted and moved, with evident disadvantages from the point of view of the operator safety.

Other systems and apparatuses are further described in tens of patent publications, such as, by pure way of example, the U.S. Pat. No. 5,523,546 filed in 1995 by the firm Mannings wherein the description of an axial inductor is reported, constituted by a tube of cooled copper which includes a ferrite core assigned to the inductive heating; this type of inductor then has become widely used over time in the reference field. Still by way of example the Chinese utility model CN201418164U in which the invention is characterized by the fact of comprising a system for adapting to the depth of the hole to be heated, as well, at last, the Korean patent KR101447106 describing a machine having a plurality of heating heads, for a greater use flexibility and reduction in the processing time, since it is possible to work at the same time on several mechanical pieces. Moreover, with reference to what is currently known, no commercialized or described apparatus is equipped with a control system capable of determining effectively the resonance frequency thereat the machine is to be operated, by avoiding at the same time to make it to operate at high powers at frequencies which otherwise would be destructive.

Considering the high costs of the plant shutdown in case of failures and maintenance of apparatuses, moreover, a problem still to be solved is to guarantee the functionality and quick effectiveness of the induction machines used for these services at time of need, by avoiding all possible problems deriving from their defects and malfunctions which would delay the maintenance activities.

Then, another additional problem which often the operators notice is to have a machine which is not easily damaged or destructed because it has operated at inappropriate frequencies and powers.

Then, the problem to be solved is that of adjusting the heating of the various inductors, in particular of the inductors having smaller sizes, which, even if they are cooled down in use, tend easily and in very short time to overheat.

Other needs still to be satisfied, at last, for example are those of having a portable machine capable of showing operating flexibility in a plurality of environments and conditions and capable of heating a variety of elements having different shapes and sizes.

### Technical Problem Solved by the Invention

The object of the present invention then is to solve the problems left unsolved by the known art, by providing a method for controlling a head for induction machine to perform tightening and releasing procedures, as defined in the independent claim 1.

The present invention further relates to a head per induction machine as defined in claim 8.

The present invention further relates to an induction machine as defined in claim 9.

Additional features of the present invention are defined in the corresponding depending claims.

The present invention involves several and evident advantages with respect to the known art.

A first important advantage is represented by the presence of a control system and method which allows to determine automatically the working frequency and to adjust automatically the power delivered depending upon the type, and above all the sizes, of the assembled inductor, so as to avoid overheating phenomena which would cause the quick deterioration or even the partial melting thereof.

The control method according to the present invention has the following advantages with respect to what existing on the market:
it allows the machine to have a capability of adapting to a much wider range of inductors (linear, loop, soft inductors, . . . );
it allows a power delivery under the best possible conditions by adapting to all changes in the parameters and then by optimizing the effectiveness;
it allows to obtain a greater reliability of the machine since it never has to work under extreme conditions.

Other advantages, together with the features and use modes of the present invention, will result evident from the following detailed description of preferred embodiments thereof, shown by way of example and not for imitative purpose.

### BRIEF DESCRIPTION OF THE FIGURES

The drawings shown in the enclosed figures will be referred to hereinafter in this description, wherein:

FIG. 1 is an exemplifying block diagram of a head for induction machine according to the present invention;

FIG. 2 is a schematic view of an induction machine according to the present invention.

### DETAILED DESCRIPTION OF PREFERRED EMBODIMENTS

The present invention will be described hereinafter with reference to the above-mentioned figures.

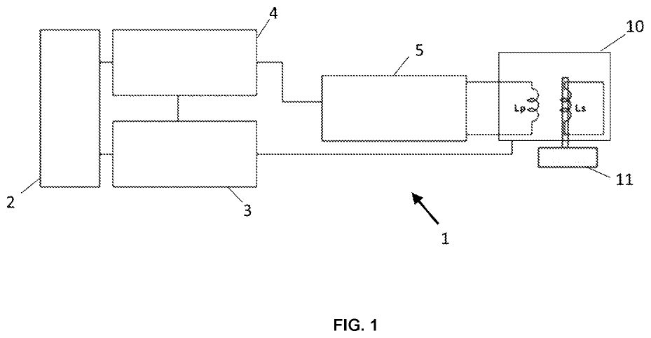

In particular, by making first of all reference to FIG. 1, this shows a block diagram generally exemplifying the architecture of a head 1 for induction machine according to the present invention.

In particular, the head 1 is based upon an architecture providing:
a controller 2;
sensors 3;
a bridge inverter 4;
a resonant circuit 5;

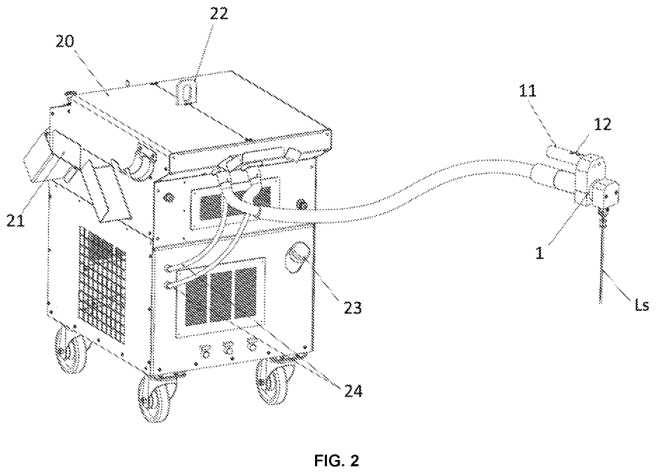

FIG. 2 relates to an induction machine according to the invention. It implements a portable system 20 comprising:
a cable-winding reel 21;
an eyebolt 22:
a tank with stopper 23;
connections for water 24.

The head 1 comprises a handle 11, a pushbutton 12 and an inductor Ls. The architecture of the head 1 is of the capacitor-type (“LCL resonant tank”) with actuation of bridge inverter type (“H bridge inverter”). This type of architecture is to be considered known and therefore it will not be described in details.

Heads of this type typically have three different resonance frequencies: F₀, F₁, F₂. In particular one thereof, the frequency F₂, can be so as to make the head to operate at a power level in strong excess with respect to the nominal one.

Consequence of such malfunction clearly is the destruction of the head itself or even of the whole machine.

Typically, the frequency F₁ is very close to the frequency F₀ which then is considered the ideal working frequency.

However, the values of F₀, F₁ and F₂ are unknown since function both of known parameters, inside the machine, and of unknown parameters variable in time related to the load 11 represented by the inductor Ls and by the mechanical piece to be heated (workpiece).

The problem is then to determine F₀, that is the frequency so that the load current and the voltage at the ends of the capacitor are in phase.

The automatic control system 2 then has to implement a control method capable of detecting the resonance frequency F₀ (typically in a range comprised between 10 KHz and 30 KHz) by avoiding to stress the system in a destructive way.

Let's consider, in fact, by way of example, the case of a machine in which F₀=10 KHz and F₂=19.5 KHz.

Let's further suppose that Fₛₜₐᵣₜ=20 KHz is the frequency used upon ignition to start the search for F₀. It results evident that the control has to operate at the frequency F₂ before detecting the frequency F₀. The crossing of F₂ during the machine start-up phase would involve the destructive effects mentioned above.

The method for controlling and determining the resonance frequency F₀ according to the present invention, then, performs the initial scanning in frequency—to detect the working frequency F₀—so as to use a very low power level with respect to the final working one.

However, this approach, even if it guarantees the system integrity, induces not linear strong effects in the inverter of the head.

The distortions associated to the not linearities produce a not negligible error in the estimation of F₀ in case the same low- and high-power control law is used.

Therefore, according to the present invention, the devised method provides to operate the control and determination of the resonance frequency F0 as described hereinafter.

In order to avoid destructive effects, the machine upon ignition is then actuated so that the head is fed with a power Pₘᵢₙ equal to about 2% of the nominal power Pₙ and at a frequency Fₛₜₐᵣₜ equal to about 20 KHz, intermediate in the provided operating range.

The control system implements a four finite-state machine wherein the first state is dedicated to the ignition and to the control of the system parameters, whereas the subsequent states are overall dedicated:
to detect the resonance frequency F₀;
to update in real time F₀ in function of the changes in the load conditions due to the temperature;
to control in real time the delivered power so as to keep it as much as possible close to Pₙ.

The aim of the state machine is then to go from the initial condition Fₛₜₐᵣₜ, Pₘᵢₙ to the final one F₀, Pₙ in a wholly automatic way and then to keep this condition during the machine operativity.

### State 1: Ignition and Operativity at Minimum Power

In this state the system aims at starting to deliver power and to verify that all operating parameters are correct. Possible anomalies (short circuits, open circuits, not assembled inductor, . . . ) are detected thanks to provided suitable sensors, when the used power is a small fraction (2%) of the nominal one, thus by avoiding to cause damage to the system. The power reduction prevents even the limit case in which Fₛₜₐᵣₜ is close to F₂ and can cause locking conditions or failures.

Upon leaving state 1 the machine is then operative and is working under the conditions Fₛₜₐᵣₜ, Pₘᵢₙ.

### State 2: Operativity at Partial Power

The head is brought to a higher power P_{mid} (about 50% of Pₙ). Upon leaving state 2 the system is operative under the conditions Fₛₜₐᵣₜ, P_{mid}.

### State 3: Search for Frequency F₀

Under the conditions Fₛₜₐᵣₜ, P_{mid} the control system varies the frequency Fₛₜₐᵣₜ searching for F₀.

Considering that the system is in power but not yet at the definitive values, the not linearities remain. In this case the error signal used at the entrance of the frequency searching system is equal to:

∈₁=|\vec{I_{load}}|²−|\vec{I_{c}}|² (1)

where \vec{I_{load}} is the load current, \vec{I_{c}} is the current in the capacitor.

Once reached the condition ∈₁=0 by means of a controller of integral proportional type, the detected resonance frequency F₀ₐₚₚ is not yet enough precise.

In fact, even if it guarantees ∈₁ a robust solution in detecting the direction of searching for F₀ (the error sign orientates the search for F₀ on values higher than or lower than Fₛₜₐᵣₜ), it does not result to be as much effective in detecting a precise solution.

Upon leaving state 3 the system is operative under the conditions F₀ₐₚₚ, P_{mid}.

### State 4: Regime Operation

The error signal of the frequency searching system is updated automatically to the new value:

∈₂=|\vec{I_{load}}|²−(|\vec{I_{c}}|²+|\vec{I_{L}}|²) (2)

where \vec{I_{L}} is the current in the bridge.

The frequency is then varied by means of a control loop of integral proportional type, until the condition ∈₂=0 results.

Moreover, an additional control loop of integral proportional type provides to increase the delivered power having as reference Pₙ and as error signal:

∈₃=P−Pₙ (3)

where P is the actually delivered power.

The power increase produces linear effects which make ∈₂ very effective in detecting the searched resonance condition.

The regime condition is then detected by the error reset conditions:
∈₂=0, in the resonance frequency searching loop;
∈₃=0, in the power control loop.

The two control loops remain always active—during the machine operativity—in order to compensate the load variations induced by increases in temperature. Upon leaving state 4 the system is operating at regime under conditions F₀, Pₙ.

It is to be meant that each one of the technical solutions implemented in the preferred embodiments, herein described by way of example, can be advantageously combined, differently from what described, with the other ones, to create additional embodiments belonging to the same inventive core and however all within the protective scope of the herebelow reported claims.

1. A method for controlling a head of an induction machine for heating a load, equipped with a bridge inverter and capacitor, for determining an operating resonance frequency (F₀) in a frequency range between a minimum frequency (Fₘᵢₙ) and a maximum frequency (Fₘₐₓ) as a function of an operating nominal power (Pₙ), comprising the following steps of:
Setting a start frequency (Fₛₜₐᵣₜ) to an intermediate value between said minimum and maximum frequencies (Fₘᵢₙ, Fₘₐₓ) and a start power (Pₘᵢₙ) equal to a fraction of said nominal power (Pₙ), for the initial start-up of the machine;
Increasing the operating power by bringing it from the start power (Pₘᵢₙ) to an intermediate power (Pmid) equal to about 50% of said nominal power (Pₙ);
Applying a first control loop wherein:
a load current \vec{I_{load}} and a capacitor current \vec{I_{c}} are measured to calculate a first error parameter (∈₁):
∈₁=|\vec{I_{load}}|²−|\vec{I_{c}}|²; e
the working frequency is changed, by determining an approximate frequency value (F₀ₐₚₚ) so that ∈₁=0;
Applying a second control loop wherein:
a bridge current \vec{I_{L}} is measured to calculate a second error parameter (∈₂):
∈₂=|\vec{I_{load}}|²−(|\vec{I_{c}}|²+|\vec{I_{L}}|²);
the working frequency is changed, by determining a frequency value so that ∈₂=0, by considering this value as resonance frequency (F₀);
Applying a third control loop wherein:
the power (P) delivered to the load is measured to calculate a third error parameter (∈₃):
∈₃=P−Pₙ;
the working power is changed, by determining a power (P) delivered to the load so that ∈₃=0, that is P=Pₙ.

2. The method according to claim 1, wherein said minimum frequency (Fₘᵢₙ) is approximately equal to 10 KHz.

3. The method according to claim 1, wherein said maximum frequency (Fₘₐₓ) is approximately equal to 30 KHz.

4. The method according to claim 1, wherein said start power (Pₘᵢₙ) is approximately equal to 2% of said nominal power (Pₙ).

5. The method according claim 1, wherein said first control loop is of the proportional-integral type.

6. The method according to claim 1, wherein said second control loop is of the proportional-integral type.

7. The method according to claim 1, wherein said third control loop is of the proportional-integral type.

8. A head of induction machine for heating a load, equipped with a bridge inverter and capacitor, comprising a control system for the determination of an operating resonance frequency (F₀) in a frequency range between a minimum frequency (Fₘᵢₙ) and a maximum frequency (Fₘₐₓ) as a function of an operating nominal power (Pₙ) configured to implement a method according to claim 1.

9. An induction machine for heating a load, comprising a head according to claim 8.
